(19) United States
(12) Patent Application Publication
(10) Pub. No.: US 2025/0265335 A1
(43) Pub. Date: Aug. 21, 2025

(54) COGNITIVE DATA REPATRIATION AND DATA REMOVAL

(71) Applicant: INTERNATIONAL BUSINESS MACHINES CORPORATION, ARMONK, NY (US)

(72) Inventors: Joseph W. Dain, Tucson, AZ (US); Christopher J. Vollmar, Mississauga (CA); Sandeep Ramesh Patil, Pune (IN); Frank N. Lee, Sunset Hills, MO (US); Nilesh Prabhakar Bhosale, Pune (IN)

(21) Appl. No.: 19/201,124

(22) Filed: May 7, 2025

Related U.S. Application Data
(63) Continuation-in-part of application No. 18/208,096, filed on Jun. 9, 2023.

(51) Int. Cl. G06F 21/55; G06F 21/56

(52) U.S. Cl. CPC G06F 21/554; G06F 21/568

(57) ABSTRACT

Provided are techniques for cognitive data repatriation and data removal. An event that triggers review of a file is received. A classification of the file is identified. The classification of the file is used to identify a data review ruleset. A process selected from a group consisting of repatriation of data in the file and removal of the data in the file is performed based on the event and the data review ruleset.

### BACKGROUND

Embodiments of the invention relate to cognitive data repatriation and data removal triggered by an event in an edge computing environment.

Edge computing is a relatively rapidly emerging computing model. It is estimated that a majority portion of enterprises run varying levels of data processing at an Internet of Things (IoT) Edge. An edge computing model places enterprise applications relatively closer to the location at which the data is created, and the location at which actions are to be performed using such data. Edge computing models typically require a decentralized approach to application design, and bring with them new challenges of workload and data management across thousands of endpoints.

Data management is often considered the number one challenge associated with edge computing. This data management issue is sometimes referred to as a “data gravity” problem, and it pertains to ensuring data processing at the edge is in compliance with various regulatory standards. For example, the Federal Communications Commission (FCC) dictates that fifth-generation (5G) radio frequency (RF) data cannot be moved across state boundaries. In another example, the Payment Card Industry Data Security Standard (PCI-DSS) dictates that data containing sensitive cardholder information must be tracked and managed in predetermined manners. For example, cardholder information is not allowed to be stored in a public cloud. Similar constraints exist for other governing and/or controlling standards and other information handling regulations.

Currently there are no conventional techniques for ensuring that data that is scheduled to be replicated and/or migrated from a first node to a second node in an edge computing environment is done so according to the regulations mentioned above. In other words, it is completely up to each customer to ensure that data is managed at an edge in a manner that does not violate regulations, and there are no known standardized techniques for ensuring this. Accordingly, there is a longstanding technique for actively managing this “data gravity” problem that exists in conventional edge computing environments.

Conventional techniques also leave it to the users to properly move or delete data as regulations change.

### SUMMARY

In accordance with certain embodiments, a computer-implemented method is provided for cognitive data repatriation and data removal. In such embodiments, an event that triggers review of a file is received. A classification of the file is identified.

The classification of the file is used to identify a data review ruleset. A process selected from a group consisting of repatriation of data in the file and removal of the data in the file is performed based on the event and the data review ruleset.

In accordance with other embodiments, a computer program product comprises one or more computer-readable storage media and program instructions stored on the one or more computer-readable storage media executable by a processor to perform one or more operations for cognitive data repatriation and data removal. In such embodiments, an event that triggers review of a file is received. A classification of the file is identified.

The classification of the file is used to identify a data review ruleset. A process selected from a group consisting of repatriation of data in the file and removal of the data in the file is performed based on the event and the data review ruleset.

In accordance with yet other embodiments, a computer system comprises a processor set, one or more computer-readable storage media, and program instructions stored on the one or more computer-readable storage media executable by the processor set to perform one or more operations for cognitive data repatriation and data removal. In such embodiments, an event that triggers review of a file is received. A classification of the file is identified. The classification of the file is used to identify a data review ruleset. A process selected from a group consisting of repatriation of data in the file and removal of the data in the file is performed based on the event and the data review ruleset.

Other embodiments and approaches of the present invention will become apparent from the following detailed description, which, when taken in conjunction with the drawings, illustrate by way of example the principles of the invention.

### BRIEF DESCRIPTION OF THE DRAWINGS

Referring now to the drawings in which like reference numbers represent corresponding parts throughout:

FIG. 1 is a diagram of a computing environment, in accordance with certain embodiments.

FIG. 2 is a diagram of a tiered data storage system, in accordance with certain embodiments.

FIG. 3A is a flowchart of a method, in accordance with certain embodiments.

FIG. 3B is a flowchart of sub-operations of an operation of the flowchart of FIG. 3A, in accordance with certain embodiments.

FIG. 4 is a system, in accordance with certain embodiments.

FIG. 5 is an application graphical user interface, in accordance with certain embodiments.

FIG. 6 illustrates a computing environment with a data review code in accordance with certain embodiments.

FIG. 7 illustrates, in a flowchart, operations for cognitive data repatriation and data removal triggered by an event in accordance with certain embodiments.

FIGS. 8A and 8B illustrate, in a flowchart, operations for repatriating and/or removing data in accordance with certain embodiments.

FIG. 9 illustrates, in a flowchart, operations for cognitive data repatriation and data removal in an edge computing environment.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The following description discloses several preferred approaches of systems, methods and computer program products for data movement and/or replication compliance in an edge computing environment.

In one general approach, a computer-implemented method includes using a determined classification of a predetermined file to determine a data compliance ruleset that applies to data of the predetermined file. Using the determined classification of the predetermined file to determine the predetermined data compliance ruleset that applies to the data of the predetermined file ensures that an applicable and relevant ruleset is prepared and ready to be applied in the event that the data is scheduled to be moved and/or replicated from a first node to a second node in the edge computing environment. More specifically, as a result of determining an applicable ruleset that applies to data of the predetermined file, the move and/or replication operation is not thereafter delayed as the ruleset may be applied upon a determination being made that the move and/or replication operation is scheduled.

In response to a determination that the data of the predetermined file is scheduled to be moved and/or replicated from a source node to a target node of an edge computing environment, the determined data compliance ruleset is applied to the data of the predetermined file. Application of the determined data compliance ruleset to the data of the predetermined file in response to a determination that the data of the predetermined file is scheduled to be moved and/or replicated from a source node to a target node of an edge computing environment enables a determination to be made whether such movement should in fact not be performed. It should be noted that by determining whether such movement should in fact not be performed, before the movement is performed, ensures that the data compliance ruleset is never violated, and movement events that would otherwise result in such violations are preferably cancelled.

The method further includes preventing the scheduled movement and/or replication of the data of the predetermined file from occurring, in response to a determination that the scheduled movement and/or replication of the data of the predetermined file violates at least one rule of the determined data compliance ruleset. Preventing the scheduled movement and/or replication of the data from occurring in response to a determination that such a scheduled movement and/or replication would otherwise violate one or more rules of the determined data compliance rule enables several performance benefits in the edge computing environment. For example, it may be noted that conventional techniques described herein would otherwise allow similar scheduled movement and/or replications to occur despite the scheduled movement and/or replications violating one or more laws and/or regulations. Accordingly, these conventional techniques waste processing resources in performing these movement and/or replication operations because the data moved and/or replicated to the target device is removed from the target device upon discovering the error. In sharp contrast, using the techniques of the novel approaches described herein, movement and/or replication operations that violate rules of a determined data compliance ruleset are prevented from being performed. In doing so, processing potential that would otherwise be unnecessarily expended is preserved.

The determined data compliance ruleset includes a plurality of rules, and in response to a determination that the scheduled movement and/or replication of the data of the predetermined file does not violate any of the rules of the determined data compliance ruleset, the scheduled movement and/or replication of the data of the predetermined file is caused to occur. By causing the scheduled movement and/or replication of the data of the predetermined file to occur in response to a determination that such a scheduled movement and/or replication does not violate one or more rules of the determined data compliance rule, operations of the edge computing environment are ensured to comply with governing and/or contractual rules. Relatively often, data compliance rules are based on measures that protect data, e.g., maintaining data on private versus public storage.

Accordingly, the techniques described herein protect user data from being subjected to damaging and/or malicious actors, e.g., such as unauthorized devices attempting to access the data, devices attempting to intercept the data, etc. This further improves performance of the edge computing environment by avoiding events that would otherwise consume processing potential in recovering from.

The method further includes causing the data of the predetermined file to be classified according to predetermined classes of data, where natural language processing operations are performed for classifying the data of the predetermined file. Classifying the data ensures that processing that is thereafter performed as a result of applying rules of a determined ruleset to the data, is not inaccurate. In other words, classification of the data enables a relatively accurate applicable ruleset to be determined for the data of the predetermined file. Without determining such a classification, at least some of the rules that would otherwise be applied to the data of the predetermined file would be non-applicable. Accordingly, the classification of the data of the predetermined file relatively reduces the amount of processing that is performed for analyzing whether the data is able to be migrated and/or replicated.

The classes of data are selected from the group consisting of: Federal Communications Commission (FCC) data, financial data, health data, data subject to predetermined consumer privacy acts, and data subject to predetermined data protection regulations. This group of classes of data is particularly relevant in the field of data movement in that it includes types of data that are typically subject to different rules and regulations in different jurisdictions throughout the world. Accordingly, the techniques described herein ensure that movement of these relevant classes of data in a way that would violate one or more rules of the determined data compliance ruleset are considered and avoided.

The target node is a core node of the edge computing environment. Movement of data to a core node is applicable in many business applications. Accordingly, the techniques described herein ensure that business practices with respect to the movement of data adhere to the determined data compliance ruleset.

A first rule of the determined data compliance ruleset does not allow movement and/or replication of the data across countries. The scheduled movement and/or replication of the data of the predetermined file is determined to violate the first rule in response to a determination that the source node is located in a first country and the target node is located in a second country that is different than the first country. Identifying cases in which the scheduled movement and/or replication of the data would otherwise violate one or more rules of the determined data compliance rule enables several performance benefits in the edge computing environment. For example, it may be noted that conventional techniques described herein would otherwise allow similar scheduled movement and/or replications to occur despite the scheduled movement and/or replications violating one or more laws and/or regulations. Accordingly, these conventional techniques waste processing resources in performing these movement and/or replication operations because the data moved and/or replicated to the target device is removed from the target device upon discovering the error. In sharp contrast, using the techniques of the novel approaches described herein, movement and/or replication operations that violate rules of a determined data compliance ruleset are prevented from being performed. In doing so, processing potential that would otherwise be unnecessarily expended is preserved.

A second rule of the determined data compliance ruleset does not allow movement and/or replication of the data across states. The scheduled movement and/or replication of the data of the predetermined file is determined to violate the second rule in response to a determination that the source node is located in a first state and the target node is located in a second state that is different than the first state. As indicated above, identifying cases in which the scheduled movement and/or replication of the data would violate one or more rules of the determined data compliance ruleset enables processing potential that would otherwise be unnecessarily expended to be preserved.

A third rule of the determined data compliance ruleset does not allow movement and/or replication of the data across county lines of a state. The scheduled movement and/or replication of the data of the predetermined file is determined to violate the third rule in response to a determination that the source node is located in a first county and the target node is located in a second county that is different than the first county. As indicated above, identifying cases in which the scheduled movement and/or replication of the data would violate one or more rules of the determined data compliance ruleset enables processing potential that would otherwise be unnecessarily expended to be preserved.

A fourth rule of the determined data compliance ruleset is based on a predetermined contractual agreement between at least two organizations associated with the data. The fourth rule does not allow movement and/or replication of the data from a private to a public domain. The scheduled movement and/or replication of the data of the predetermined file is determined to violate the fourth rule in response to a determination that the source node stores data on a private domain and the target node stores data on a public domain that is different than the private domain. As indicated above, identifying cases in which the scheduled movement and/or replication of the data would violate one or more rules of the determined data compliance ruleset enables processing potential that would otherwise be unnecessarily expended to be preserved. These techniques furthermore ensure that a predetermined contractual agreement between at least two organizations associated with the data is met and maintained. This mitigates an amount of computer processing that would otherwise be performed in recovering from a breach of the predetermined contractual agreement.

In another general approach, a computer program product includes a computer program product comprising a computer readable storage medium having program instructions embodied therewith. The program instructions are readable and/or executable by a computer to cause the computer to perform any embodiments of the foregoing methodology.

In another general approach, a system includes a processor, and logic integrated with the processor, executable by the processor, or integrated with and executable by the processor. The logic is configured to perform any embodiments of the foregoing methodology.

Various embodiments of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

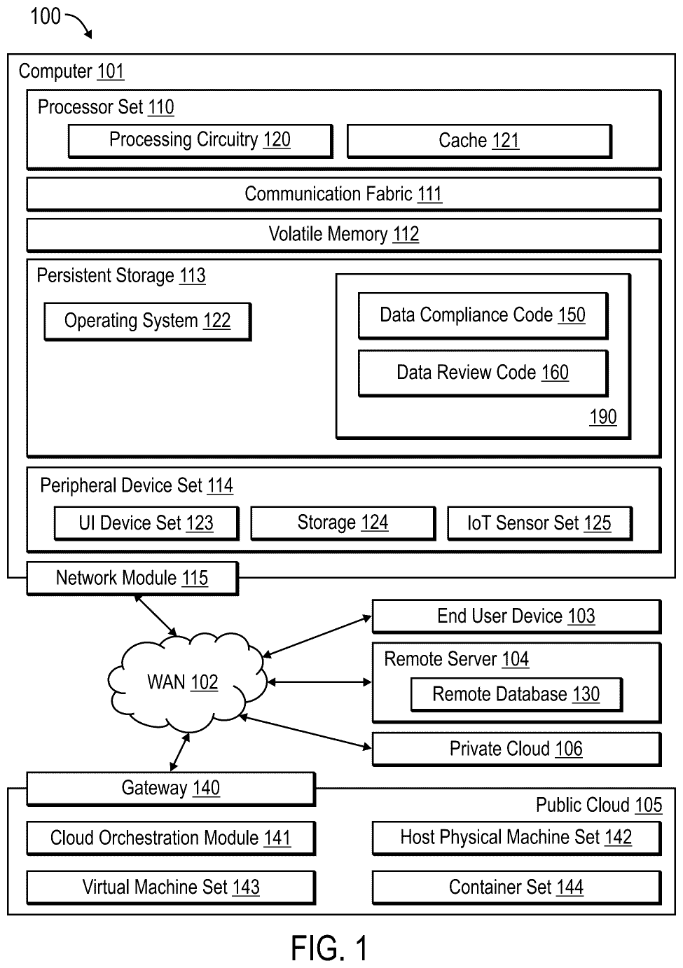

Computing environment 100 of FIG. 1 contains an example of an environment for the execution of at least some of the computer code involved in performing the inventive methods, such as data compliance code 150 and data review code 160 of block 190. In addition to block 190, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 190, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set 110 may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 190 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 190 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

In some embodiments, a system according to various approaches may include a processor and logic integrated with and/or executable by the processor, the logic being configured to perform one or more of the process steps recited herein. The processor may be of any configuration as described herein, such as a discrete processor or a processing circuit that includes many components such as processing hardware, memory, I/O interfaces, etc. By integrated with, what is meant is that the processor has logic embedded therewith as hardware logic, such as an application specific integrated circuit (ASIC), a FPGA, etc. By executable by the processor, what is meant is that the logic is hardware logic; software logic such as firmware, part of an operating system, part of an application program; etc., or some combination of hardware and software logic that is accessible by the processor and configured to cause the processor to perform some functionality upon execution by the processor. Software logic may be stored on local and/or remote memory of any memory type, as known in the art. Any processor known in the art may be used, such as a software processor module and/or a hardware processor such as an ASIC, a FPGA, a central processing unit (CPU), an integrated circuit (IC), a graphics processing unit (GPU), etc.

Of course, this logic may be implemented as a method on any device and/or system or as a computer program product, according to various approaches.

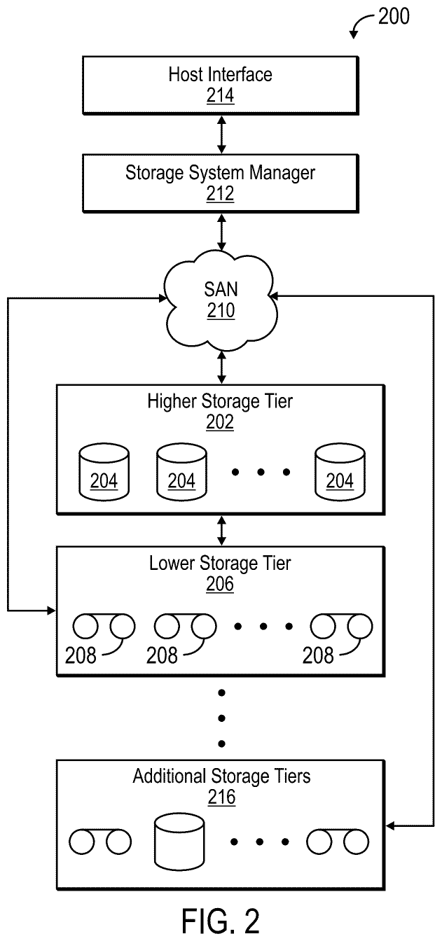

Now referring to FIG. 2, a storage system 200 is shown according to one approach. Note that some of the elements shown in FIG. 2 may be implemented as hardware and/or software, according to various approaches. The storage system 200 may include a storage system manager 212 for communicating with a plurality of media and/or drives on at least one higher storage tier 202 and at least one lower storage tier 206. The higher storage tier(s) 202 preferably may include one or more random access and/or direct access media 204, such as hard disks in hard disk drives (HDDs), nonvolatile memory (NVM), solid state memory in solid state drives (SSDs), flash memory, SSD arrays, flash memory arrays, etc., and/or others noted herein or known in the art. The lower storage tier(s) 206 may preferably include one or more lower performing storage media 208, including sequential access media such as magnetic tape in tape drives and/or optical media, slower accessing HDDs, slower accessing SSDs, etc., and/or others noted herein or known in the art. One or more additional storage tiers 216 may include any combination of storage memory media as desired by a designer of the system 200. Also, any of the higher storage tiers 202 and/or the lower storage tiers 206 may include some combination of storage devices and/or storage media.

The storage system manager 212 may communicate with the drives and/or storage media 204, 208 on the higher storage tier(s) 202 and lower storage tier(s) 206 through a network 210, such as a storage area network (SAN), as shown in FIG. 2, or some other suitable network type. The storage system manager 212 may also communicate with one or more host systems (not shown) through a host interface 214, which may or may not be a part of the storage system manager 212. The storage system manager 212 and/or any other component of the storage system 200 may be implemented in hardware and/or software, and may make use of a processor (not shown) for executing commands of a type known in the art, such as a central processing unit (CPU), a field programmable gate array (FPGA), an application specific integrated circuit (ASIC), etc. Of course, any arrangement of a storage system may be used, as will be apparent to those of skill in the art upon reading the present description.

In more approaches, the storage system 200 may include any number of data storage tiers, and may include the same or different storage memory media within each storage tier. For example, each data storage tier may include the same type of storage memory media, such as HDDs, SSDs, sequential access media (tape in tape drives, optical disc in optical disc drives, etc.), direct access media (CD-ROM, DVD-ROM, etc.), or any combination of media storage types. In one such configuration, a higher storage tier 202, may include a majority of SSD storage media for storing data in a higher performing storage environment, and remaining storage tiers, including lower storage tier 206 and additional storage tiers 216 may include any combination of SSDs, HDDs, tape drives, etc., for storing data in a lower performing storage environment. In this way, more frequently accessed data, data having a higher priority, data needing to be accessed more quickly, etc., may be stored to the higher storage tier 202, while data not having one of these attributes may be stored to the additional storage tiers 216, including lower storage tier 206. Of course, one of skill in the art, upon reading the present descriptions, may devise many other combinations of storage media types to implement into different storage schemes, according to the approaches presented herein.

According to some approaches, the storage system (such as 200) may include logic configured to receive a request to open a data set, logic configured to determine if the requested data set is stored to a lower storage tier 206 of a tiered data storage system 200 in multiple associated portions, logic configured to move each associated portion of the requested data set to a higher storage tier 202 of the tiered data storage system 200, and logic configured to assemble the requested data set on the higher storage tier 202 of the tiered data storage system 200 from the associated portions.

As mentioned elsewhere above, edge computing is a relatively rapidly emerging computing model. It is estimated that a majority portion of enterprises run varying levels of data processing at an Internet of Things (IoT) edge. An edge computing model places enterprise applications relatively closer to the location at which the data is created, and the location at which actions are to be performed using such data. Edge computing models typically require a decentralized approach to application design, and bring with them new challenges of workload and data management across thousands of endpoints.

Data management is often considered the number one challenge associated with edge computing. This data management issue is sometimes referred to as a “data gravity” problem, and it pertains to ensuring data processing at the edge is in compliance with various regulatory standards. For example, the Federal Communications Commission (FCC) dictates that 5G radio frequency (RF) data cannot be moved across state boundaries. In another example, the Payment Card Industry Data Security Standard (PCI-DSS) dictates that data containing sensitive cardholder information must be tracked and managed in predetermined manners. For example, cardholder information is not allowed to be stored in a public cloud. Similar constraints exist for other governing and/or controlling standards and other information handling regulations.

Currently there are no conventional techniques for ensuring that data that is scheduled to be replicated and/or migrated from a first node to a second node in an edge computing environment is done so according to the regulations mentioned above. In other words, it is completely up to each customer to ensure that data is managed at a node in a manner that does not violate regulations, and there are no known standardized techniques for ensuring this. Accordingly, there is a longstanding technique for actively managing this “data gravity” problem that exists in conventional edge computing environments.

In sharp contrast to the deficiencies in the conventional approaches described above, the techniques described herein combine an event driven artificial intelligence (AI) metadata workflow that uses cognitive techniques such as natural language processing and/or named entity recognition, optical character recognition, speech to text, regular expression pattern matching, etc., to identify data that contains information subject to one or more compliance regulations. A data compliance ruleset that is determined to apply to the identified data is then applied to the data to ensure that the data is not migrated and/or replicated within an edge computing environment in such a way that violates one or more rules of the determined data compliance ruleset. These techniques may furthermore be combined with a location and/or sovereignty of each edge node and core instance in a topology which is cross referenced by data sovereignty rules of various data compliance regulations to automatically ensure that data is not replicated or moved from node to node or node to core in a manner that would violate one or more rules of a determined ruleset, without interaction from a user during the execution of replication policies and/or when presenting users with valid replication targets when executing different replication policies.

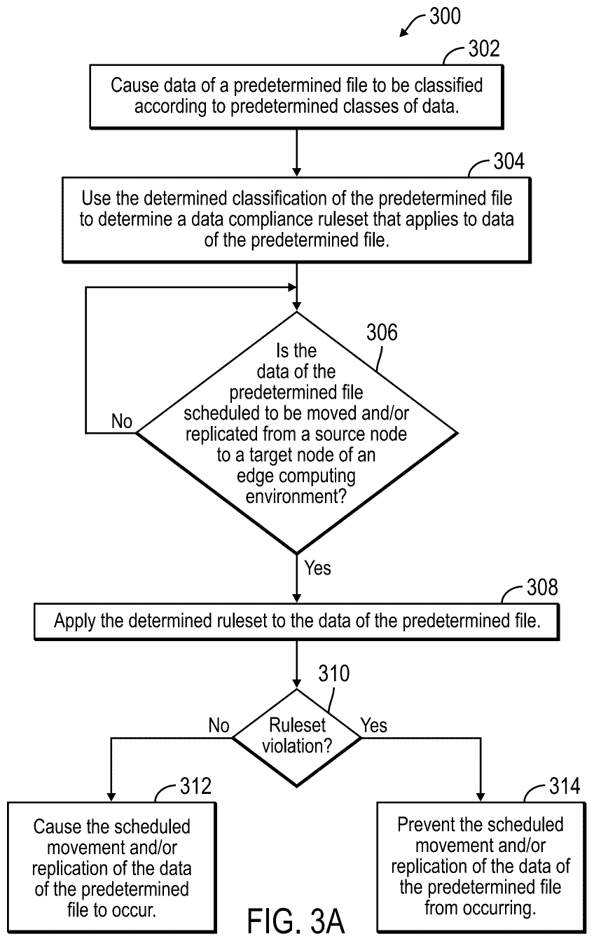

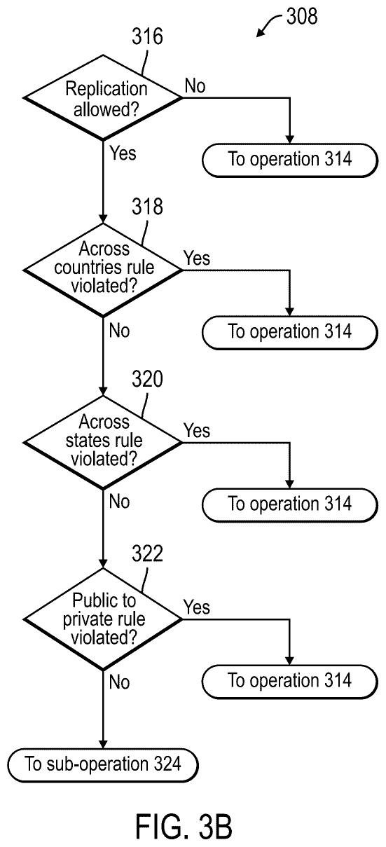

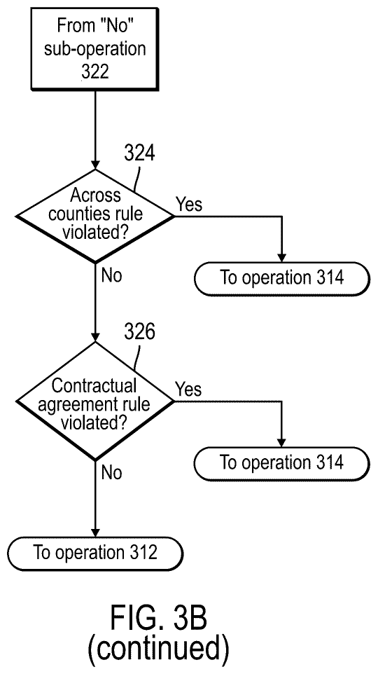

Now referring to FIG. 3A, a flowchart of a method 300 is shown according to one approach. The method 300 may be performed in accordance with the present invention in any of the environments depicted in FIGS. 1-5, among others, in various approaches. Of course, more or fewer operations than those specifically described in FIG. 3A may be included in method 300, as would be understood by one of skill in the art upon reading the present descriptions.

Each of the steps of the method 300 may be performed by any suitable component of the operating environment. For example, in various approaches, the method 300 may be partially or entirely performed by a computer, or some other device having one or more processors therein. The processor, e.g., processing circuit(s), chip(s), and/or module(s) implemented in hardware and/or software, and preferably having at least one hardware component, may be utilized in any device to perform one or more steps of the method 300. Illustrative processors include, but are not limited to, a central processing unit (CPU), an application specific integrated circuit (ASIC), a field programmable gate array (FPGA), etc., combinations thereof, or any other suitable computing device known in the art.

It may be prefaced that method 300 may be performed in a type of edge computing environment that would become apparent to one of ordinary skill in the art after reading the descriptions herein. In some preferred approaches, the edge computing environment may include a plurality of edge devices, which depending on the approach may be, e.g., a computer, a server, a processing circuit, tiers of a tiered data storage system, etc. At least some of the edge devices may be located at different geographical locations, e.g., different cities, different counties, different countries, different states, different continents, etc., that may have different governing regulations with respect to the management of data. Furthermore, in some approaches, the edge computing environment includes a core, e.g., a core edge device. In some preferred approaches, each of the plurality of edge devices are computers and/or servers that are all configured to communicate and selectively relay data to a core that is at a different location than each of the edge devices. In one or more of such approaches, applications may be deployed on the edge devices where the edge devices are located at branches of a corporation while the core is located at headquarters of the corporation.

In some approaches, at least some of the edge devices have files stored on the edge devices. Data of the files may, in some approaches, be classified, e.g., such as in response to a determination that at least some of the data of a predetermined file stored on a first edge device is scheduled to be moved and/or replicated to a second edge device. Operation 302 includes causing data of the predetermined file to be classified according to one or more predetermined classes of data. In one approach, a first of the classes of data includes Federal Communications Commission (FCC) data. In another approach, the classes of data may include financial data, e.g., banking records, purchase history, loan documents, credit card numbers, etc. In yet some other approaches, the classes of data include health data, e.g., such as Health Insurance Portability and Accountability Act (HIPAA) data. In another approach, the classes of data may include data subject to predetermined consumer privacy acts, e.g., such as California Consumer Privacy Act Data. The classes of data may additionally and/or alternatively include data subject to predetermined data protection regulations, e.g., such as the General Data Protection Regulation.

It should be noted that user data that is used in the techniques described herein is preferably only used subsequent to gaining permission to do so from users that the data pertains to. More specifically, this permission is preferably obtained in such a way that the user has the opportunity to consider and review details of how their information will be used (to assist the user in making an informed decision), and the user is thereafter presented with an option to opt-in, e.g., an expressly performed opt-in selection. Thereafter, in some approaches, the user is preferably reminded of their opt-in, and ongoingly presented with features, e.g., output for display on a user device associated with the user, that relatively easily allow the user to retract their previous election to opt-in. Note that these features may be presented to the user in any one or more formats, e.g., audibly, visually, braille, in multiple languages, etc. For example, the user may be presented with an unambiguous opt-out selection feature which, if elected by the user, terminates collection and use of data associated with the user, erases previously used data associated with the user, and notifies the user of the course of action taken to respect the user's selection of the opt-out selection feature. In the event that the user does not want to have their data used in one or more of the operations described herein, this decision is respected, and the user is preferably not again presented with such an option unless the user thereafter requests to reconsider the opt-in feature, e.g., based on a change in their decision. It should also be noted that the techniques described herein do not profit form and exploit user data, but in sharp contrast, protect user data by ensuring that the data is not moved and/or replicated against one or more data compliance rulesets.

One or more techniques that would become apparent to one of ordinary skill in the art after reading the descriptions herein may be used for classification of the data of the predetermined file. For example, in some approaches, natural language processing operations may, in some approaches, be performed for classifying the data of the predetermined file. During such classifying, the processing operations may parse textual data of the predetermined file to determine whether at least a predetermined number and/or frequency of predetermined keywords of a given one of the predetermined classes are included in the predetermined file. The processing operations may additionally and/or alternatively include inspecting the data for predetermined terms that are consistent with one or more regulatory compliance mandates, e.g., predetermined keywords. Additional classifying techniques that may additionally and/or alternatively be performed include, e.g., other cognitive techniques such as named entity recognition, optical character recognition, speech to text, regular expression pattern matching, etc.

A primary benefit of classifying the data includes ensuring that processing that is thereafter performed as a result of applying rules of a determined ruleset to the data, is not inaccurate. In other words, classification of the data enables a relatively accurately applicable ruleset to be determined for the data of the predetermined file. Without determining such a classification, at least some of the rules that would otherwise be applied to the data of the predetermined file would be non-applicable. Accordingly, the classification of the data of the predetermined file relatively reduces the amount of processing that is performed for analyzing whether the data is able to be migrated and/or replicated. For example, operation 304 includes using a determined classification of a predetermined file to determine a predetermined data compliance ruleset that applies to data of the predetermined file. For context, the data compliance ruleset that applies to data of the predetermined file is preferably one that scrutinizes, e.g., applies rules that must be met, the data with respect to the determined classification of the data. For example, in response to a determination that the data is classified to be health data, a data compliance ruleset that includes a plurality of HIPAA rules may be determined to apply to the data of the predetermined file. In another example, in response to a determination that the data is classified to be data subject to a predetermined consumer privacy act, a data compliance ruleset that includes a plurality of consumer privacy act rules may be determined to apply to the data of the predetermined file.

Using the determined classification of the predetermined file to determine the predetermined data compliance ruleset that applies to the data of the predetermined file ensures that an applicable and relevant ruleset is prepared and ready to be applied in the event that the data is scheduled to be moved and/or replicated from a first node to a second node in the edge computing environment. More specifically, as a result of determining an applicable ruleset that applies to data of the predetermined file, the move and/or replication operation is not thereafter delayed as the ruleset may be applied upon a determination being made that the move and/or replication operation is scheduled.

It should be noted that, in some approaches, the data of the predetermined file may change over time, e.g., have one or more portions deleted, have additional data added to the predetermined file, etc. This may result in a relevant classification of the data changing and/or an additional classification applying to the data. Accordingly, in response to a determination that the data has been modified at least a predetermined amount, the predetermined file may be again classified and/or a determination may be made as to whether another and/or an additional ruleset applies to data of the predetermined file. In some approaches, only portions of the data determined to have been changed, e.g., the new data, the amended data, etc., may be considered during this process in order to preserve processing potential of a processing circuit that is performing method 300.

Decision 306 includes determining whether data of the predetermined file is scheduled to be moved and/or replicated from a source node to a target node of the edge computing environment. In some preferred approaches, the source node is a node in which the data is currently stored, and the target node is a core node of the edge computing environment, on which the data is to be stored as a result of performance of a scheduled migration and/or replication operation. In some approaches, an input/output (I/O) queue of a processing circuit of the edge computing environment is monitored to determine whether the data of the predetermined file is scheduled to be moved and/or replicated from a source node to a target node of the edge computing environment. In response to a determination that the data of the predetermined file is not scheduled to be moved and/or replicated from a source node to a target node of the edge computing environment, e.g., as illustrate by the “No” logical path of decision 306, monitoring for such a scheduled move and/or replication is ongoingly performed. In contrast, in response to a determination that the data of the predetermined file is scheduled to be moved and/or replicated from a source node to a target node of the edge computing environment, e.g., as illustrated by the “Yes” logical path of decision 306, the determined data compliance ruleset is applied to the data of the predetermined file, e.g., see operation 308. Various techniques for applying the determined data compliance ruleset to the data of the predetermined file is described below, e.g., see FIG. 3B. Application of the determined data compliance ruleset to the data of the predetermined file in response to a determination that the data of the predetermined file is scheduled to be moved and/or replicated from a source node to a target node of an edge computing environment enables a determination to be made whether such movement should in fact not be performed. It should be noted that by determining whether such movement should in fact not be performed, before the movement is performed, ensures that the data compliance ruleset is never violated, and movement events that would otherwise result in such violations are preferably cancelled.

Looking to FIG. 3B, exemplary sub-operations of applying a determined ruleset to data of a predetermined file are illustrated in accordance with one approach, one or more of which may be used to perform operation 308 of FIG. 3A. However, it should be noted that the sub-operations of FIG. 3B are illustrated in accordance with one approach which is in no way intended to limit the invention. That is, FIG. 3B includes examples of, but not an exclusive list of, checks.

It should be prefaced that the sub-operations of the flowchart of FIG. 3B illustrate a first possible logical flow for applying a determined ruleset to data of a predetermined file. More specifically, in this logical flow, each of the decisions represent a different rule of the determined ruleset that is applied, e.g., six different rules. However, in some other approaches, the determined data compliance ruleset may be different, and thereby may include a different number and/or type of rules.

With continued reference to FIG. 3B, sub-operation 316 includes application of a first rule of a predetermined dataset. Specifically, application of the rule of sub-operation 316 includes determining whether replication of the data of the predetermined file is allowed. In some approaches, such a determination may include checking whether a predetermined bit is set. Such a bit may be selectively set, e.g., based on input received from a device associated with an owner of the data, based on input received from a device associated with an administrator of the edge computing environment, etc., to control whether the data is capable of being moved and/or replicated. In some approaches, in response to a determination that replication of the data of the predetermined file is not allowed, e.g., as illustrated by the “No” logical path of sub-operation 316, the method continues to operation 314. In contrast, in some approaches, in response to a determination that replication of the data of the predetermined file is allowed, e.g., as illustrated by the “Yes” logical path of sub-operation 316, the method optionally continues to sub-operation 318.

Sub-operation 318 includes applying another rule of the determined data compliance ruleset. Specifically, the rule of the determined data compliance ruleset does not allow movement and/or replication of the data across countries. Accordingly, in some approaches, application of the rule includes determining whether a country in which the source node is located is different than a country that the target node is located in. The scheduled movement and/or replication of the data of the predetermined file is, in some approaches, determined to violate the first rule in response to a determination that the source node is located in a first country and the target node is located in a second country that is different than the first country. In response to such a determination, the method optionally continues to operation 314, e.g., as illustrated by the “Yes” logical path of sub-operation 318. In contrast, in some approaches, in response to a determination that the source node is located in a first country and the target node is located in the first country, e.g., as illustrated by the “No” logical path of sub-operation 316, the rule is determined to not be violated and the method optionally continues to sub-operation 320.

Another rule of the determined data compliance ruleset is additionally and/or alternatively applied in sub-operation 320. Specifically, the rule of the determined data compliance ruleset does not allow movement and/or replication of the data across states of a country. Accordingly, in some approaches, application of the rule includes determining whether a state in which the source node is located is different than a state that the target node is located in. The scheduled movement and/or replication of the data of the predetermined file is, in some approaches, determined to violate the rule in response to a determination that the source node is located in a first state and the target node is located in a second state that is different than the first state. In response to such a determination, the method optionally continues to operation 314, e.g., as illustrated by the “Yes” logical path of sub-operation 320. In contrast, in some approaches, in response to a determination that the source node is located in a first state and the target node is also located in the first state, e.g., as illustrated by the “No” logical path of sub-operation 316, the rule is determined to not be violated and the method optionally continues to sub-operation 322.

Another rule of the determined data compliance ruleset is additionally and/or alternatively applied in sub-operation 322. Specifically, the rule of the determined data compliance ruleset does not allow movement and/or replication of the data from a private domain to a public domain. Accordingly, in some approaches, application of the rule includes determining whether a storage protocol of the source node is different than a storage protocol of the target node. More specifically, in some approaches, assuming that the source node currently stores and/or accesses the data using a private domain, a determination may be made as to whether the target node currently stores and/or accesses the data using a public domain. The scheduled movement and/or replication of the data of the predetermined file is, in some approaches, determined to violate the rule in response to a determination that the source node currently stores and/or accesses the data using a private domain and the target node currently stores and/or accesses the data using a public domain. In response to such a determination, the method optionally continues to operation 314, e.g., as illustrated by the “Yes” logical path of sub-operation 322. In contrast, in some approaches, in response to a determination that the target node currently stores and/or accesses the data using a private domain, the scheduled movement and/or replication of the data of the predetermined file may be determined to not be violated, e.g., as illustrated by the “No” logical path of sub-operation 322, and the method optionally continues to sub-operation 324.

Another rule of the determined data compliance ruleset is additionally and/or alternatively applied in sub-operation 324. Specifically, the rule of the determined data compliance ruleset does not allow movement and/or replication of the data across county lines of at least one state. Accordingly, in some approaches, application of the rule includes determining whether a county in which the source node is located is different than a county that the target node is located in. The scheduled movement and/or replication of the data of the predetermined file is, in some approaches, determined to violate the rule in response to a determination that the source node is located in a first county and the target node is located in a second county that is different than the first county. In response to such a determination, the method optionally continues to operation 314, e.g., as illustrated by the “Yes” logical path of sub-operation 324. In contrast, in some approaches, in response to a determination that the source node is located in a first county and the target node is also located in the first county, e.g., as illustrated by the “No” logical path of sub-operation 324, the rule is determined to not be violated and the method optionally continues to sub-operation 326.

In some optional approaches, a rule of the determined data compliance ruleset may be based on a predetermined contractual agreement between at least two organizations associated with the data, e.g., see sub-operation 326. For example, such contractual agreements may define parameters that the rules are based on such as, e.g., where the data can and/or cannot be stored, security requirements of a device that is performing the scheduled data movement and/or replication, processing potential of a device that is performing the scheduled data movement and/or replication, role based access control (RBAC) credentials of a device performing the scheduled data movement and/or replication, predetermined locations where the data may be stored, etc. In some other approaches, the contractual agreements may define parameters that the rules are based on such as, e.g., data not being migrated to a node used by a user with less than a predetermined historical security compliance score, data not being migrated to a node that does not have at least two-stage password credentials, data not being migrated and/or replicated using wireless signals and instead only using hardwire connections, etc. In some approaches, the predetermined contractual agreement may additionally and/or alternatively define a rule that the data is not migrated and/or replicated to a node at a location that has predetermined dangerous weather events currently occurring and/or forecasted to occur within a predetermined amount of time. This way, processing associated with the replication and/or movement output operations is not expended for no result where it is relatively likely that the predetermined weather events are predicted to be likely of interrupting or failing the movement and/or replication. In response to a determination that movement and/or replication of the data to the target node would violate contractual obligations of the predetermined contractual agreement, e.g., as illustrated by the “Yes” logical path of sub-operation 326, the method continues to operation 314. In contrast, in response to a determination that movement and/or replication of the data to the target node would not violate contractual obligations of the predetermined contractual agreement, e.g., as illustrated by the “No” logical path of sub-operation 326, the method continues to operation 312. Accordingly, these techniques ensure that a predetermined contractual agreement between at least two organizations associated with the data is met and maintained. This mitigates an amount of computer processing that would otherwise be performed in recovering from a breach of the predetermined contractual agreement.

Referring again to FIG. 3A, method 300 includes determining whether any of the rules of the determined data compliance ruleset are violated, e.g., see operation 310. As illustrated in FIG. 3B, in some approaches, the determined data compliance ruleset includes a plurality of rules. Accordingly, in some approaches, in response to a determination that the scheduled movement and/or replication of the data of the predetermined file does not violate any of the rules of the determined data compliance ruleset, e.g., as illustrated by the “No” logical path of operation 310, the scheduled movement and/or replication of the data of the predetermined file is caused to occur, e.g., see operation 312. The scheduled movement and/or replication of the data of the predetermined file may be caused to occur by, e.g., issuing an authorization instruction to a device that requests the movement and/or replication, setting a bit that performance of the movement and/or replication is based on, instructing a controller of the source node, and/or any other technique for causing a movement and/or replication to be performed that would become apparent to one of ordinary skill in the art after reading the descriptions herein. In contrast, in response to a determination that the scheduled movement and/or replication of the data of the predetermined file violates at least one of the rules of the determined data compliance ruleset, e.g., as illustrated by the “Yes” logical path of operation 310, the scheduled movement and/or replication of the data of the predetermined file is prevented from occurring, e.g., see operation 314. The scheduled movement and/or replication of the data of the predetermined file may be prevented from occurring by, e.g., issuing a denial to a device that requests the movement and/or replication, unsetting a bit that performance of the movement and/or replication is based on, instructing a controller of the source node, and/or any other technique for causing a movement and/or replication to be performed that would become apparent to one of ordinary skill in the art after reading the descriptions herein.

Preventing the scheduled movement and/or replication of the data from occurring in response to a determination that such a scheduled movement and/or replication would otherwise violate one or more rules of the determined data compliance rule enables several performance benefits in the edge computing environment. For example, it may be noted that the conventional techniques described elsewhere above would otherwise allow similar scheduled movement and/or replications to occur despite the scheduled movement and/or replications violating one or more laws and/or regulations. Accordingly, these conventional techniques waste processing resources in performing these movement and/or replication operations because the data moved and/or replicated to the target device is removed from the target device upon discovering the error. In sharp contrast, using the techniques of the novel approaches described herein, movement and/or replication operations that violate rules of a determined data compliance ruleset are prevented from being performed. In doing so, processing potential that would otherwise be unnecessarily expended is preserved. Furthermore, by causing the scheduled movement and/or replication of the data of the predetermined file to occur in response to a determination that such a scheduled movement and/or replication does not violate one or more rules of the determined data compliance ruleset, operations of the edge computing environment are ensured to comply with governing and/or contractual rules. Relatively often, data compliance rules are based on measures that protect data, e.g., maintaining data on private versus public storage. Accordingly, the techniques described herein protect user data from being subjected to damaging and/or malicious actors, e.g., such as unauthorized devices attempting to access the data, devices attempting to intercept the data, etc. This further improves performance of the edge computing environment by avoiding events that would otherwise consume processing potential in recovering from.

In some approaches, the techniques described above in method 300 may be implemented as an algorithm that is used to prevent data from being replicated in a manner that would violate regulatory compliance. The algorithm is preferably executed for each file in a list of files to be replicated in a replication policy. In one illustrative use case and by way of example, a file classified as containing FCC data may be part of a replication policy to copy data from an edge site in the city of Atlanta to an edge site in the city of Tampa. A data catalog may be queried to determine the data classification for the file. In this case the query result is that the data is classified as FCC data. Thereafter, in some approaches, the data catalog is queried to determine replication compliance restriction(s) for FCC regulated data, e.g., a ruleset of data compliance rules that apply to FCC regulated data. In this case, the query may reveal that FCC regulated data cannot cross state boundaries. It may be noted that, additional replication compliance restriction information may be returned by the query, e.g., a rule that defines whether the data can be replicated at all, a rule that defines whether the data can be replicated between country lines, a rule that defines whether the data can be replicated across state and/or province boundaries, a rule that defines whether the data can be replicated to public clouds, a rule that defines whether or not data can be replicated between different counties, etc. Depending on the approach, additional replication rules may also be defined according to different data regulations.

In another use case of the techniques described above in method 300, the module may be affixed to a transmission line, e.g., with permission to do so and monitor the transmissions passed along the transmission line. In one example, the transmission line may be a 5G transmission line. The module may there be caused to monitor and audit transmissions of the 5G transmission line to prevent data from being transmitted, e.g., moved and/or replicated from a first node to a second node via the 5G transmission line, in response to a determination that such a transmission violates rules of a ruleset that is determined to apply to the data.

In some approaches, after obtaining the information mentioned above, the algorithm may apply the determined data compliance ruleset to determine whether the FCC regulated data can be replicated. Next, the algorithm may be caused to check whether the data can be replicated across the country, whether the data can be replicated across different states, whether the state (Florida in the current example) replication target matches the source state (Georgia in the current example), etc. In this example, the states do not match, and therefore, in response to such a determination, the replication is rejected and the algorithm ends. In some preferred approaches, the algorithm is repeated for each file in the replication dataset. Results of the checking may be stored persistently for audit purposes, e.g., to a predetermined database, appended to the instances of data, as metadata of the data, at each of the nodes where the data is stored, only at a core of the edge computing environment, etc.

In some approaches, the operations of method 300 may be performed by an AI model that is trained using a predetermined training set of data. For example, in some approaches, various of the operations noted above may be deployed in a trained state of a trained AI model. Training of the AI model, in some approaches, may be performed by applying a predetermined training data set to learn how to classify data of a predetermined file, determine a data compliance ruleset that applies to the data, and/or determine whether to allow data movement and/or replication based on a determination of whether the rules of the ruleset are violated. Initial training may include reward feedback that may, in some approaches, be implemented using a subject matter expert (SME) that generally understands the classifications and/or rulesets that should be generated based on the training data. However, to prevent costs associated with relying on manual actions of a SME, in another approach, reward feedback may be implemented using techniques for training a BERT model, as would become apparent to one skilled in the art after reading the present disclosure. Once a determination is made that the AI model achieves a redeemed threshold of accuracy of performing the operations described herein during this training, a decision that the model is trained and ready to deploy for performing techniques and/or operations of method 300 may be performed. In some further approaches, the AI model may be a neuromyotonic AI model that may improve performance of computer devices in an infrastructure associated with classifying the data and enforcing fata compliance rulesets, because the neuromyotonic AI model may not need an SME and/or iteratively applied training with reward feedback in order to accurately perform operations described herein. Instead, the neuromyotonic AI model is configured to itself make determinations described in operations herein. Weight values may, in some approaches, be used by the AI reasoning model to collect and analyze information and/or feedback potentially received from edges about movements and/or replications of data. Such an AI model ensures that all data in an edge computing environment maintains compliance with governing and/or regulatory measures, where the scale of such analysis and determinations would not otherwise be feasible for a human to perform. This is because humans are not able to efficiently dynamically monitor whether movement and/or replication operations comply with such measures, and would otherwise incorporate processing delays and errors in the edge computing environment in the process of attempting to do so. Accordingly, management of operations described herein is not able to be achieved by human manual actions.

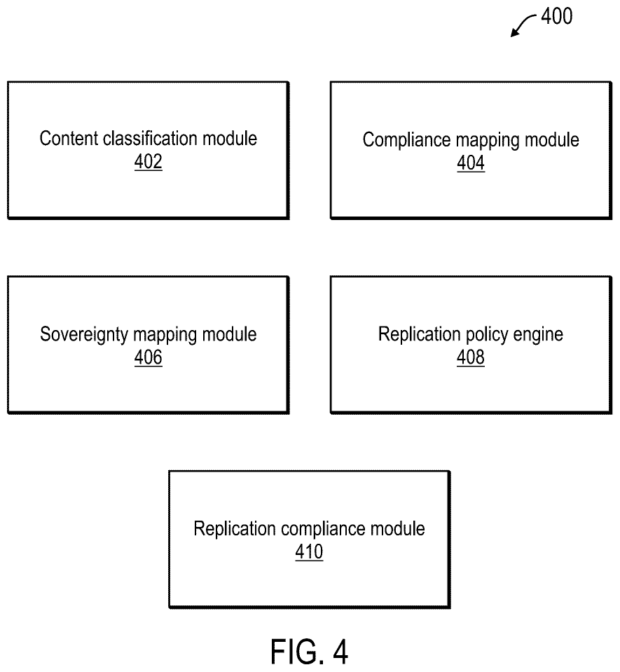

FIG. 4 depicts a system 400, in accordance with one approach. As an option, the present system 400 may be implemented in conjunction with features from any other approach listed herein, such as those described with reference to the other FIGS. Of course, however, such system 400 and others presented herein may be used in various applications and/or in permutations which may or may not be specifically described in the illustrative approaches listed herein. Further, the system 400 presented herein may be used in any desired environment.

In one preferred approach, the system 400 includes a plurality of modules for ensuring data compliance in an edge computing environment. For example, a first of the modules includes a content classification module 402. The content classification module 402 is configured to, e.g., instructed to, inspect data of a predetermined file looking for terms that are consistent with one or more regulatory compliance mandates. For example, assuming that a credit card number is found in the data, the data of the predetermined file may be subject to proper data handling according to the PCI-DSS specification. Other examples include, but are not limited to GDPR, HIPPAA, CCPA, and FCC.

The system 400 additionally includes a compliance mapping module 404. The compliance mapping module 404 is configured to define the data placement rules, e.g., data “gravity” rules, for each regulatory compliance mandate. For example, data classified as being FCC data cannot move across state boundaries, while other data classified as HIPPAA data cannot be put in a public cloud.

In some other approaches, the compliance mapping module 404 may define that a classification of data is FCC and that data cannot cross a state boundary. In another approach, the compliance mapping module 404 may define that a classification of data is HIPPAA data and that a data placement rule that data containing personal identifiable information (PII) cannot be moved to a public cloud.

A sovereignty mapping module 406 is additionally included in the system 400 in some approaches. The sovereignty mapping module 406 is configured to register the location of an edge appliance in terms of predetermined location parameters, e.g., county, city, state, country, etc. The system 400 additionally includes a replication policy engine 408. The replication policy engine 408 is preferably configured to define the source and targets for data replication and data movement, and also identifies the source data itself that should be managed. In some approaches, the source data may be based on a custom tag, a directory, bucket, a list of files, or any other means of providing a corpus of data to replicate that would become apparent to one of ordinary skill in the art after reading the descriptions herein.

In some approaches, the replication policy engine includes filtering criteria that defines the data that is to be moved or copied in the heterogeneous storage landscape. The filtering criteria may take any system metadata and/or custom metadata tags. The policy may also define the replication target(s) or destination(s).

In some approaches, the sovereignty mapping module 406 is caused to obtain and store the location of each component in an edge topology. For example, user input may be received and may include, e.g., the city, county, state, and country of a particular edge appliance during installation and configuration. The location of public cloud instances that are part of the topology and any other relevant edge component may also be registered. Additionally, the location may be tagged as “private” or “public” to distinguish between private secure data centers vs public cloud and/or relatively less secure environments.

The system 400 additionally includes a replication compliance module 410 that is configured to ensure that data that is to be replicated does not violate one or more regulatory compliance data gravity restrictions, e.g., rules of a determined data compliance ruleset. In some approaches, the system may additionally and/or alternatively include a data catalog that stores system and custom metadata about all the data in the edge computing environment.

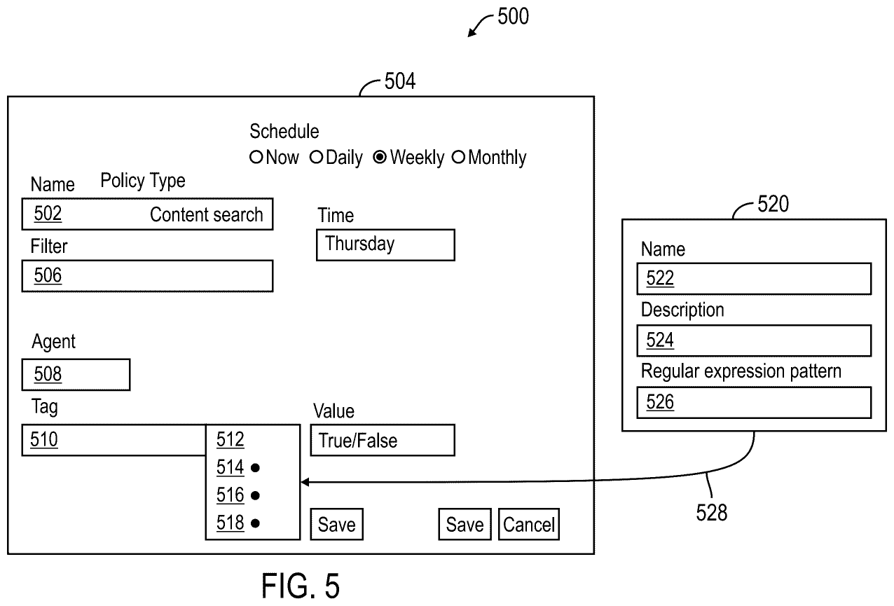

FIG. 5 depicts an application graphical user interface 500, in accordance with one approach. As an option, the present application graphical user interface 500 may be implemented in conjunction with features from any other approach listed herein, such as those described with reference to the other FIGS. Of course, however, such application graphical user interface 500 and others presented herein may be used in various applications and/or in permutations which may or may not be specifically described in the illustrative approaches listed herein. Further, the application graphical user interface 500 presented herein may be used in any desired environment.

The graphical user interface 500 illustrates one approach of the content classification module described herein. A content classification policy, e.g., see policy name 502 and policy type “Content search” in first window 504, may take filtering criteria, e.g., see filter 506 that defines the data that is to be inspected in the heterogeneous storage landscape. The filtering criteria may take any system metadata and/or custom metadata tags, e.g., see agent 508 and tag 510. A policy may also include one or more terms to look for in the source data. For example, a search expression may be defined which specifies search expression variables 512, e.g., Email ID 514, credit card information 516, social security information 518, etc. In some approaches, an add-on regular expression may be created to customize search patterns that are performed, e.g., see second window 520 of the graphical user interface 500. In some approaches, such an add-on regular expression may include a name, e.g., a name 522, a description 524, a regular expression pattern 526, etc., which may be appended to one or more other search expressions, e.g., see operation 528. A schedule that controls when the module runs may also be defined, e.g., see the model is set to run “Weekly” in the current approach.

A value, e.g., true or false, may also be specified so that the data is not shown in the results (to protect user data), but rather just an indication of whether or not such data exists in a considered predetermined file. Techniques such as regular expression pattern matching, natural language processing based on named entity recognition, optical character recognition, speech to text, etc. may be used in a pipeline to extract relevant information from the predetermined file during classification of the data. For example, in some approaches, this information may be stored in an easily searchable manner and may map to one or more classification tags. According to a more specific approach, a policy may inspect all .pdf files in a particular data source for credit card numbers using regular expressions and if they are found, set the classification tag to PCI-DSS for those files.

### Cognitive Data Repatriation and Date Removal

Compliance, shifting geo-political and contractual alignments, and ransomware/data exfiltration attacks present a unique challenge for enterprises that maintain data across multiple state-level and other boundaries and across shared company alliance agreements such as joint ventures, Original Equipment Manufacturers (OEMs), manufacturer/supplier agreements, etc. Having jointly shared data that crosses one or more of these boundaries creates an issue in the event of a cyber attack or the termination of these relationships, whether sudden (conflict or ransomware based) or planned (treaty termination). Ransomware may include malware, wiper-ware and other data destructive attacks. Leaving sensitive, controlled, or confidential data orphaned or behind or inaccessible by the owning organization creates a risk (Intellectual Property (IP) or other) of loss or legal compliance impact.

With embodiments, the data review code 160 provides for the ability to take action against controlled data to either repatriate, delete or take other actions in the event of an event that puts the data at risk. The data review code 160 extends from the ability to apply access control policies across disparate edge devices and to either delete the data before or after repatriation and leverage data discovery/classification information from third party tools to extend its reach to structured data sets that exist inside backup and archive applications and take similar actions to delete and/or repatriate data. With embodiments, the data review code 160 proves options to secure erase and/or perform key shredding as part of the data removal process and provide a compliance report for provability of proper repatriation and/or removal of any data left behind as a result of policy restrictions or repository (i.e., storage system) restrictions.

In certain embodiments, the data review code 160 provides an approach to addressing data risk and repatriation in response to an event. This creates a way for organizations to manage and limit risk in scenarios in which data is at risk of loss or retention by third parties who are no longer authorized to access the data.

In certain embodiments, the data review code 160 provides an event based, two-person integrity confirmed data repatriation of files, backup copies, and archive copies based on classification and requirements. Two person integrity is an example of a dual or multiple party approval system. For example, someone is not able to take certain actions without the electronic or other type of agreement by one or more other persons, potentially within a pre-defined period of time (e.g., if 3 of 5 people agree within a 2 hour window, the action may proceed).

In certain embodiments, the data review code 160 provides an event based, two-person integrity confirmed data deletion at the source of files, backup copies, and archive copies based on classification or requirements either post repatriation or without repatriation using secure shredding, key deletion or other techniques. Shredding and key deletion are ways of securely deleting or removing the ability to read data, without going through a full delete exercise that may require high processing power.

In certain embodiments, the data review code 160 provides integration with backup and archive applications to find, repatriate or policy delete data based on classification, controls or requirements, including releasing data locks where available. A policy delete may be described as a deletion request to execute a certain type of deletion policy specific to the backup or archive application.

In certain embodiments, the data review code 160 provides integration with security and data classification tooling for structured data to determine file information and repatriation or deletion in the backup or archive repositories.

In certain embodiments, the data review code 160 provides compliance reporting for provability of repatriation, secure deletion, and orphaned data and its nature and classification.

In certain embodiments, the data review code 160 uses a determined classification of a file to identify a data review ruleset that applies to data of the file. Using the determined classification of the file to determine the predetermined data review ruleset that applies to the data of the file ensures that an applicable and relevant ruleset is prepared and ready to be applied in response to an event that triggers review of the file for repatriation and/or removal.

In response to receiving an event that triggers review of the file at an edge computing environment for repatriation and/or removal, the data review code 160 uses the data review ruleset to determine whether to repatriate and/or remove the file. Application of the determined data review ruleset to the data of the file may repatriate and remove data so that the data is not stored at an edge device that the device should not be stored at due to the event.

The determined data review ruleset includes a plurality of rules, and in response to the event that triggers a review for repatriation and/or removal, the data review code 160 applies the plurality of rules to determine whether to perform repatriation and/or removal. Repatriation refers to moving data from an edge device to an original edge device (e.g., moving the data from a target node (the edge device) back to a source node (the original edge device)). Removal refers to deleting data at an edge device, deleting one or more backup copies of the data, and/or deleting one or more archive copies of the data.

The data review code 160 causes the data of the file to be classified according to predetermined classes of data, where natural language processing operations are performed for classifying the data of the file. Classifying the data ensures that processing that is thereafter performed as a result of applying rules of a determined ruleset to the data, is not inaccurate. In other words, classification of the data enables a relatively accurate applicable data review ruleset to be determined for the data of the file. Without determining such a classification, at least some of the rules that would otherwise be applied to the data of the predetermined file would be non-applicable. Accordingly, the classification of the data of the predetermined file relatively reduces the amount of processing that is performed for analyzing whether the data is able to be repatriated and/or removed.

The classes of data may be selected from the group consisting of: Federal Communications Commission (FCC) data, financial data, health data, data subject to predetermined consumer privacy acts, and data subject to predetermined data protection regulations. This group of classes of data is particularly relevant in the field of data movement in that it includes types of data that are typically subject to different rules and regulations in different jurisdictions throughout the world. Accordingly, the techniques described herein ensure that movement of these relevant classes of data in a way that would violate one or more rules of the determined data compliance ruleset are considered and avoided.

With embodiments, the data review code determines where to repatriate the data to. For example, if repatriating the data crosses a boarder or geographic boundary that is not allowed, then the data review code 160 does not initiate that repatriation action, and, instead, the data review code 160 finds a target that is in compliance (i.e., is allowed to store that data).

Although embodiments refer to files, embodiments are also applicable to objects and other forms of storing data.

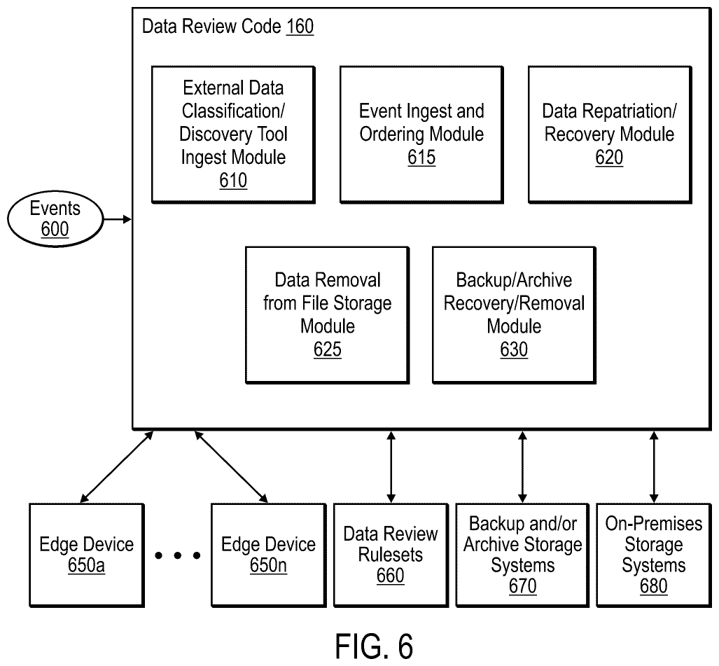

FIG. 6 illustrates a computing environment with the data review code 160 in accordance with certain embodiments. In certain embodiments, the data review code 160 includes an external data classification/discovery tool ingest module 610, an event ingest and ordering module 615, a data repatriation/recovery module 620, a data removal from file storage module 625, and a backup/archive recovery/removal module 630.

The data review code 160 receives events, which trigger review of files on the edge devices 650a . . . 650n for repatriation (e.g., to an on-premises storage system 680) or removal (i.e., deletion) using the data review rulesets 660. In response to the event, the data review code 160 also checks for backup copies and/or archive copies stored on the backup and/or archive storage systems for repatriation (e.g., to an on-premises storage system 680) or removal (i.e., deletion).

The external data classification/discovery tool ingest module 610 obtains information for associating a classification with a file.

The event ingest and ordering module 615 receives events that trigger a review of files for repatriation and/or removal.

The a data repatriation/recovery module 620 moves data from a node (e.g., edge device 650a . . . 650n) back to an original data storage side. For example, the data repatriation/recovery module 620 may move the data from one or more edge devices 650a . . . 650n to the on-premises storage system 680 of an organization that owns the data.

The data removal from file storage module 625 removes the file from the node (e.g., edge device 650a . . . 650n). In certain embodiments, the data removal from file storage module 625 removes data from within the file.

The backup/archive recovery/removal module 630 identifies backup copies and archive copies and their locations so that these copies may be repatriated and/or removed. For example, the backup/archive recovery/removal module 630 may have an initial copy of the data from yesterday and may have an additional 29 days of backups, then a replication of that data to another backup system at the disaster recovery site. The backup/archive recovery/removal module 630 would identify all of these copies of the data so that recall (i.e., repatriate) and/or delete commands may be issued for these copies.

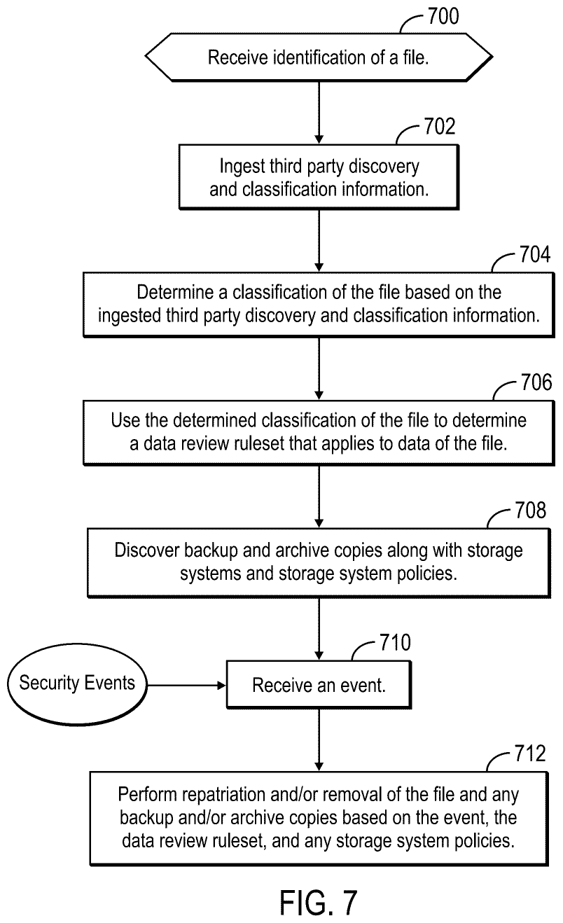

FIG. 7 illustrates, in a flowchart, operations for cognitive data repatriation and data removal triggered by an event in accordance with certain embodiments. Control begins at block 700 with the data review code 160 receiving identification of a file. In certain embodiments, a system administrator or other user may provide the file. In block 702, the data review code 160 ingests third party discovery and classification information. In block 704, the data review code 160 determines a classification of the file based on the third party discovery and classification information, and/or historical classification of similar files, and/or AI classification, and/or by querying a data catalog. In certain embodiments, determining the classification of the file includes automated data management with classification, tagging, and feature extraction.

In block 706, the data review code 160 uses the determined classification of the file to determine a data review ruleset that applies to data of the file.

In block 708, the data review code 160 discovers backup and archive copies along with storage systems (e.g., repositories) and attached storage system policies. In certain embodiments, storage systems (e.g., a file system or Network Attached Storage (NAS) device) have separate storage system policies for data retention, protection, and replication to other storage systems. Such storage system policies are different from a backup or archive system policy. The data review code takes these storage system policies into account when repatriating and/or deleting data.

In block 710, the data review code 160 receives an event. In certain embodiments, the event is a security event. For example, the security event may be an event triggered in a Security Information and Event Management (SIEM) system or registered as part of a triggered workflow in a Security Orchestration, Automation, and Response (SOAR) system that contains the event as well as additional activities that are to be performed. In certain embodiments, a security system monitors real-world situations in real time and generates the security events based on geopolitical or other events (e.g., cyber attacks). For example, the event may be generated based on an attack in a particular area, an anomaly in a particular area, a news report of hostilities in a particular area, a rapid change in geo-political alignment, a sudden break of treaty agreements, etc. If data is on an edge device in such an area, the data review code 160 is able to repatriate and/or remove the data from that edge device to secure the data and prevent the data from being taken.

In block 712, the data review code 160 performs repatriation and/or removal of the file and any backup and/or archive copies based on the event and the data review ruleset.

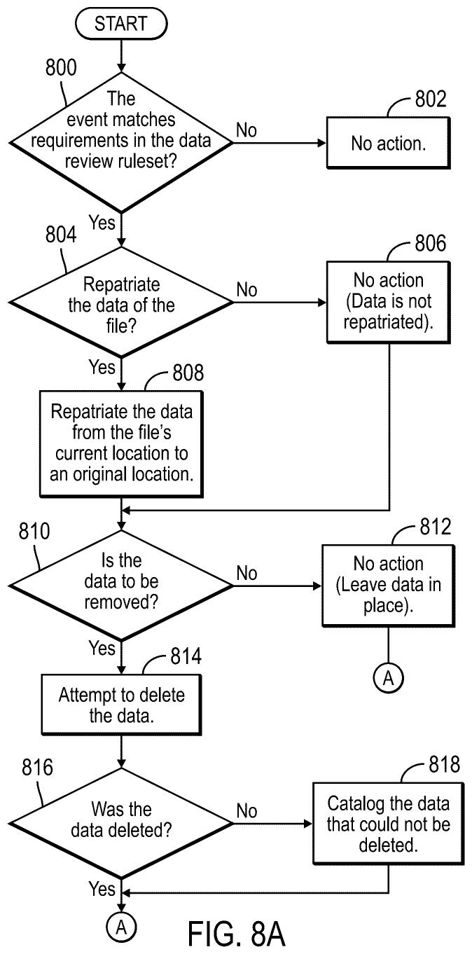

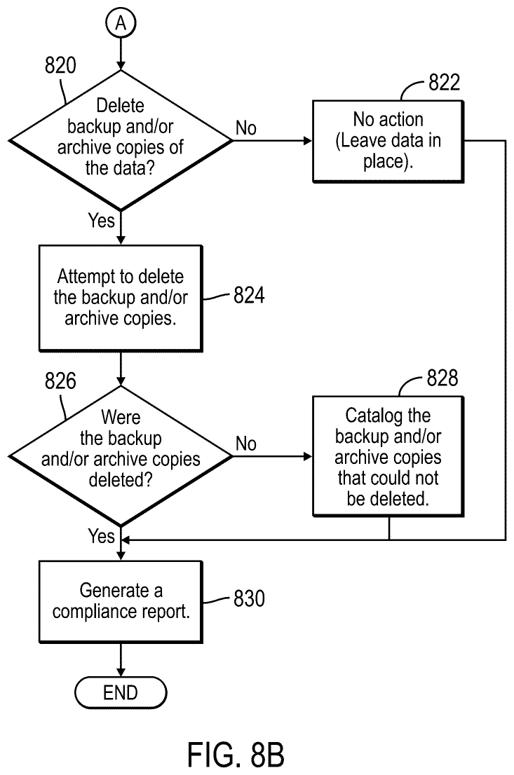

FIGS. 8A and 8B illustrate, in a flowchart, operations for repatriating and/or removing data in accordance with certain embodiments. Control begins at block 800 with the data review code 160 determining whether the event matches requirements in the data review ruleset. For example, if the event is based on a change in a trade agreement or a shift in a geo-political alignment, the data review code 160 determines whether the data review ruleset has one or more rules for such an event. If the event matches the requirements, processing continues to block 804, otherwise, processing continues to block 802. In block 802, the data review code 160 performs no action as the event does not match the requirements.

In block 804, the data review code 160 determines whether the data of the file is to be repatriated. The data review code 160 may make this determination based on a tag applied to the file or an indicator set for the file in the data review ruleset. In certain embodiments, a data review ruleset is associated with different events, in which case, there is an indicator for each combination of event and file to indicate whether repatriation is to be performed. If the data of the file is to be repatriated, processing continues to block 808, otherwise, processing continues to block 806. In block 806, the data review code 160 performs no action as the data is not repatriated. From block 806, processing continues to block 810.

In block 808, the data review code 160 repatriates the data from the file's current location to an original location. The current location may be one or more edge devices and/or one or more backup and/or archive storage systems. The original location may be an on-premises storage system of the organization that owns the data and initially moved the data to one or more edge devices and/or one or more backup and/or archive storage systems. The original location may be referred to as a “target” for the repatriation (movement) of the data, while the location of the data to be moved may be referred to as a “source”.

In block 810, the data review code 160 determines whether the data is to be removed. The data review code 160 may make this determination based on a tag applied to the file or an indicator set for the file in the data review ruleset. In certain embodiments, a data review ruleset is associated with different events, in which case, there is an indicator for each combination of event and file to indicate whether removal is to be performed. If the data is to be removed, processing continues to block 814, otherwise, processing continues to block 812. In block 812, the data review code 160 performs no action as the file is not deleted. From block 812, processing continues to block 820 (FIG. 8B).

In block 814, the data review code 160 attempts to delete the data. In block 816, the data review code 160 determines whether the data was deleted. If so, processing continues to block 820 (FIG. 8B), otherwise, processing continues to block 818. In block 818, the data review code 160 catalogs the data that could not be deleted. From block 818, processing continues to block 820 (FIG. 8B). In certain embodiments, the attempt to delete the data is not successful due to intervention at the site of the data, such as blocking the connection between the owning organization and where the data was residing. That is, the attempts of the data review code 160 to reach the end point location of the data (e.g., edge device, file system, backup system or other storage system) is blocked, so that the data review code 160 is unable to complete the delete of the data.

In block 820, the data review code 160 determines whether to delete backup and/or archive copies of the data. The data review code 160 may make this determination based on tags applied to the file or indicators set for the file in the data review ruleset. For example, a first tag or a first indicator indicates whether backup copies are to be deleted and a second tag or a second indicator indicates whether archive copies re to be deleted. The backup and archive copies may be stored in different storage systems or the same storage system, and the backup and archive copies may have the same or different schedules (e.g., nightly backups, monthly archives, etc.) In certain embodiments, a data review ruleset is associated with different events, in which case, there are indicators for each combination of event, file, and backup or archive. If the backup and/or archive copies are to be removed, processing continues to block 824, otherwise, processing continues to block 822. In block 822, the data review code 160 performs no action as the backup and/or archive copies are not deleted. From block 822, processing continues to block 830 (FIG. 8B).

In block 824, the data review code 160 attempts to delete the backup and/or archive copies. In block 826, the data review code 160 determines whether the backup and/or archive copies were deleted. If so, processing ends, otherwise, processing continues to block 828. In block 828, the data review code 160 catalogs the backup and/or archive copies that could not be deleted.

In block 830, the data review code 160 generates a compliance report that indicates the data that has been repatriated, the data that has been deleted, and the data that has been orphaned (i.e., the attempts to delete the data did not work).

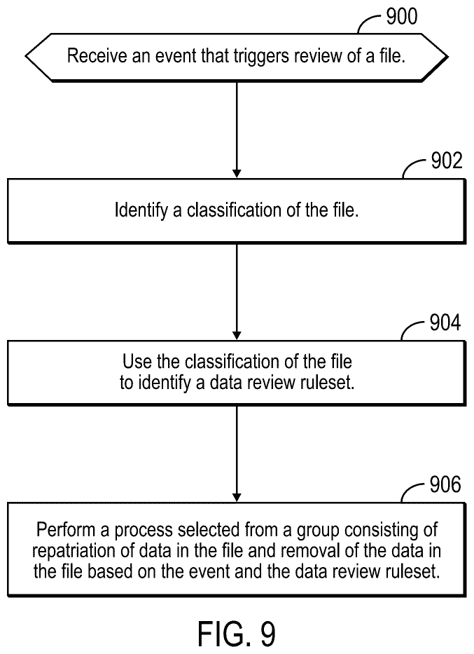

FIG. 9 illustrates, in a flowchart, operations for cognitive data repatriation and data removal in an edge computing environment. Control begins at block 900 with the data review code 160 receiving an event that triggers review of a file. In block 902, the data review code 160 identifies a classification of the file. In block 904, the data review code 160 uses the classification of the file to identify a data review ruleset. In block 906, the data review code 160 performs a process selected from a group consisting of repatriation of data in the file and removal of the data in the file based on the event and the data review ruleset.

In certain embodiments, the data review code 160 ingests third party discovery and classification information, which is used to determine the classification. In certain embodiments, the data review code 160 discovers backup and archive copies in storage systems and storage system policies, where the repatriation of the data and the removal of the data applies to the backup and archive copies and complies with the storage system policies.

In certain embodiments, the data review code 160 performs repatriation by copying the data from a current location at an edge device to an original location at an on-premises storage system. In certain embodiments, the data review code 160 performs removal by attempting to delete the data from a current location, and, in response to determining that the data was not deleted, cataloging the data that was not deleted.

In certain embodiments, the data review code 160 generates a compliance report that indicates the data that was repatriated, the data that was removed, and orphaned data that was not deleted.

In certain embodiments, the event is a security event that is generated based on monitoring real-world situations in real time.

The letter designators, such as a, among others, are used to designate an instance of an element, i.e., a given element, or a variable number of instances of that element when used with the same or different elements.

The terms “an embodiment”, “embodiment”, “embodiments”, “the embodiment”, “the embodiments”, “one or more embodiments”, “some embodiments”, and “one embodiment” mean “one or more (but not all) embodiments of the present invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the present invention need not include the device itself.

It will be clear that the various features of the foregoing systems and/or methodologies may be combined in any way, creating a plurality of combinations from the descriptions presented above.

It will be further appreciated that approaches of the present invention may be provided in the form of a service deployed on behalf of a customer to offer service on demand.

The descriptions of the various approaches of the present invention have been presented for purposes of illustration, but are not intended to be exhaustive or limited to the approaches disclosed. Many modifications and variations will be apparent to those of ordinary skill in the art without departing from the scope and spirit of the described approaches. The terminology used herein was chosen to best explain the principles of the approaches, the practical application or technical improvement over technologies found in the marketplace, or to enable others of ordinary skill in the art to understand the approaches disclosed herein.

It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims herein after appended.

What is claimed is:

1. A computer-implemented method comprising operations for:
receiving an event that triggers review of a file;
identifying a classification of the file;
using the classification of the file to identify a data review ruleset; and
performing a process selected from a group consisting of repatriation of data in the file and removal of the data in the file based on the event and the data review ruleset.

2. The computer-implemented method of claim 1, wherein the operations further comprise:
ingesting third party discovery and classification information.

3. The computer-implemented method of claim 1, wherein the operations further comprise:
discovering backup copies and archive copies in storage systems and storage system policies, wherein the repatriation of the data and the removal of the data applies to the backup copies and the archive copies and complies with the storage system policies.

4. The computer-implemented method of claim 1, wherein the operations for the repatriation of the data further comprise:
copying the data from a current location at an edge device to an original location at an on-premises storage system.

5. The computer-implemented method of claim 1, wherein the operations for the removal of the data further comprise:
attempting to delete the data from a current location; and
in response to determining that the data was not deleted, cataloging the data that was not deleted.

6. The computer-implemented method of claim 1, wherein the operations further comprise:
generating a compliance report that indicates the data that was repatriated, the data that was removed, and orphaned data that was not deleted.

7. The computer-implemented method of claim 1, wherein the event comprises a security event that is generated based on monitoring real-world situations in real time.

8. A computer program product comprising:
one or more computer-readable storage media; and
program instructions stored on the one or more computer-readable storage media executable by a processor to perform one or more operations, the computer program product comprising:
program instructions to receive an event that triggers review of a file;
program instructions to identify a classification of the file;
program instructions to use the classification of the file to identify a data review ruleset; and
program instructions to perform a process selected from a group consisting of repatriation of data in the file and removal of the data in the file based on the event and the data review ruleset.

9. The computer program product of claim 8, further comprising:
program instructions to ingest third party discovery and classification information.

10. The computer program product of claim 8, further comprising:
program instructions to discover backup and archive copies in storage systems and storage system policies, wherein the repatriation of the data and the removal of the data applies to the backup and archive copies and complies with the storage system policies.

11. The computer program product of claim 8, wherein the repatriation of the data further comprises:
program instructions to copy the data from a current location at an edge device to an original location at an on-premises storage system.

12. The computer program product of claim 8, wherein the removal of the data further comprises:
program instructions to attempt to delete the data from a current location; and
program instructions to, in response to determining that the data was not deleted, catalog the data that was not deleted.

13. The computer program product of claim 8, further comprising:
program instructions to generate a compliance report that indicates the data that was repatriated, the data that was removed, and orphaned data that was not deleted.

14. The computer program product of claim 8, wherein the event comprises a security event that is generated based on monitoring real-world situations in real time.

15. A computer system comprising:
a processor set;
one or more computer-readable storage media; and
program instructions stored on the one or more computer-readable storage media executable by the processor set to perform one or more operations comprising:
receive an event that triggers review of a file;
identify a classification of the file;
use the classification of the file to identify a data review ruleset; and
perform a process selected from a group consisting of repatriation of data in the file and removal of the data in the file based on the event and the data review ruleset.

16. The computer system of claim 15, further comprising operations to:
ingest third party discovery and classification information.

17. The computer system of claim 15, further comprising operations to:
discover backup and archive copies in storage systems and storage system policies, wherein the repatriation of the data and the removal of the data applies to the backup and archive copies and complies with the storage system policies.

18. The computer system of claim 15, wherein the operations for the repatriation of the data further comprise operations to:
copy the data from a current location at an edge device to an original location at an on-premises storage system.

19. The computer system of claim 15, wherein the operations for the removal of the data further comprise operations to:
attempt to delete the data from a current location; and
in response to determining that the data was not deleted, catalog the data that was not deleted.

20. The computer system of claim 15, wherein the operations further comprise operations to:
generate a compliance report that indicates the data that was repatriated, the data that was removed, and orphaned data that was not deleted.
